(19) United States
(12) Patent Application Publication
(10) Pub. No.: US 2011/0247804 A1
(43) Pub. Date: Oct. 13, 2011

(54) WASTE PROCESSING SYSTEM

(75) Inventor: Gary Woolsey, Houston, TX (US)

(73) Assignee: M-I L.L.C., Houston, TX (US)

(21) Appl. No.: 13/140,643

(22) PCT Filed: Dec. 18, 2009
(86) PCT No.: PCT/US09/68623

§ 371 Date: Jun. 17, 2011

Related U.S. Application Data
(60) Provisional application No. 61/140,572, filed on Dec. 23, 2008.

(51) Int. Cl. E21B 43/34; B02C 23/08; B09B 5/00

(52) U.S. Cl. 166/267; 588/249; 241/68

(57) ABSTRACT

A waste processing system including a first container having an inlet and an outlet, a separator in fluid communication with the first container, and a mechanical degrading device configured to receive an overflow from the separator. Also, a method of processing drilling waste including providing drilling waste to a source, transferring drilling waste from the source to a first container, and pumping drilling waste from the first container to a separator. The method also including receiving an overflow from the separator in a mechanical degrading device, processing the overflow in the mechanical degrading device, and discharging the processed overflow from the mechanical degrading device to a second container.

### BACKGROUND OF INVENTION

1. Field of the Disclosure

Embodiments disclosed herein relate generally to systems and methods for handling, processing and disposing of waste at a work site. More specifically, embodiments disclosed herein relate to systems and methods for processing drilling waste for injection into a downhole formation.

2. Background

In the drilling of wells, a drill bit is used to dig many thousands of feet into the earth's crust. Oil rigs typically employ a derrick that extends above the well drilling platform. The derrick supports joint after joint of drill pipe connected end-to-end during the drilling operation. As the drill bit is pushed further into the earth, additional pipe joints are added to the ever lengthening “string” or “drill string”. Therefore, the drill string includes a plurality of joints of pipe.

Fluid (e.g., “drilling mud,” “drilling fluid,” etc.) is pumped from the well drilling platform, through the drill string, and to a drill bit supported at the lower or distal end of the drill string. The drilling mud lubricates the drill bit and carries away well cuttings generated by the drill bit as it digs deeper. The cuttings are carried in a return flow stream of drilling mud through the well annulus and back to the well drilling platform at the earth's surface. When the drilling mud reaches the platform, it is contaminated with small pieces of shale and rock that are known in the industry as well cuttings or drill cuttings. Once the drill cuttings, drilling mud, and other waste reach the platform, various processing operations take place. For example, a “shale shaker” may be used to remove the drilling mud from the drill cuttings so that the drilling mud may be reused. The remaining drill cuttings, waste, and residual drilling mud (e.g., “drilling waste,” “waste,” etc.) are then transferred to a holding trough for disposal.

While the drilling mud is reusable, the drill cuttings and other solid particulate matter is generally not reusable. In some situations, even the mud may not be reused and it must be disposed. As such, drilling waste is often stored onsite for eventual removal from the drill site. Typically, the non-recycled drilling mud is disposed of separate from the drill cuttings and other waste by transporting the drilling mud via a vessel to a disposal site.

Traditional methods of disposal include dumping, bucket transport, conveyor belts, screw conveyors, and washing techniques that require large amounts of water. Adding water creates additional problems of added volume and bulk, pollution, and transport problems. Installing conveyors requires major modification to the rig area and involves extensive installation hours and expense. In some instances, the cuttings, which are still contaminated with some oil, are transported from a drilling rig to an offshore rig or ashore in the form of a thick heavy paste or slurry for injection into an earth formation. Typically, the material is put into special skips of about 10 ton capacity that are loaded by crane from the rig onto supply boats. This is a difficult and dangerous operation that may be laborious and expensive.

In addition, as hydrocarbonaceous products become rare, areas that were previously too remote and/or too cost prohibitive for production are being reconsidered. For example, some remote areas are subject to severe environmental and/or logistical constraints. Some of these areas are prone to produce drilling waste containing particulate matter, such as sand. Particulate matter like sand may cause problems because once the particulate accumulates in handling equipment, reinjection systems and/or storage containers, operations must be stopped in order to clear the particulate. Issues with sand may occur due to the particle size and composition of the sand, which cannot be degraded by a slurrification system. Thus, sand and other particulate matter may require removal from the system in order to prevent safe injection into a disposal domain, or otherwise, the sand/particulate matter must be removed from the system and disposed of through other channels, such as through onshore disposal. Thus, there exists a continuing need for more efficient slurrification methods and systems for processing drilling waste.

### SUMMARY OF INVENTION

According to one aspect, embodiments disclosed herein relate to a waste processing system including a first container having an inlet and an outlet, a separator in fluid communication with the first container, and a mechanical degrading device configured to receive an overflow from the separator.

In another aspect, embodiments disclosed herein relate to a system for processing a waste stream for downhole injection, the system including a first container having an inlet and an outlet, a separator in fluid communication with the first container, and a mechanical degrading device configured to receive an overflow from the separator. Additionally, the system including a second container in fluid communication with the first container and the mechanical degrading device, wherein eh second container is configured to receive a ground waste from the mechanical degrading device.

In another aspect, a method of processing drilling waste including providing drilling waste to a source, transferring drilling waste from the source to a first container, and pumping drilling waste from the first container to a separator. The method also including receiving an overflow from the separator in a mechanical degrading device, processing the overflow in the mechanical degrading device, and discharging the processed overflow from the mechanical degrading device to a second container.

Other aspects of the present disclosure will be apparent from the following description and the appended claims.

### BRIEF DESCRIPTION OF DRAWINGS

FIG. 1 is an isometric view of a waste processing system in accordance with embodiments of the present disclosure.

FIG. 2 is an overhead view a waste processing system in accordance with embodiments of the present disclosure.

FIG. 3 is a side view of a waste processing system in accordance with embodiments of the present disclosure.

FIG. 4 is a frontal view of a waste processing system in accordance with embodiments of the present disclosure.

FIG. 5a is an overhead sectional view of a mechanical degrading device in accordance with embodiments of the present disclosure.

FIG. 5b is an isometric view of a mechanical degrading device in accordance with embodiments of the present disclosure.

FIG. 6 is a flow diagram for a waste processing system in accordance with embodiments of the present disclosure.

FIG. 7 is a flow diagram for an alternate embodiment of a waste processing system in accordance with embodiments of the present disclosure.

### DETAILED DESCRIPTION

Embodiments disclosed herein relate generally to systems and methods for handling, processing, and disposing of waste at a drilling location. Other embodiments disclosed herein relate to systems and methods for processing drilling waste for injection into a downhole formation. More specifically, embodiments disclosed herein relate to systems and methods for handling drilling waste, including use of a grinder in a waste processing system. Examples of drilling waste include water-based and/or oil-based fluids, fluids with cuttings or other particulate matter entrained therein, recycled wellbore fluids, etc.

Embodiments of the present disclosure discussed herein are generally described as may be found at a drilling site. Examples of drilling sites may be onshore or offshore, and may include on-shore rigs or off-shoe rigs, which may further include platforms, submersibles, semi-submersibles, spars, tension line rigs, and tender assist rigs. Furthermore, because the systems disclosed herein may be incorporated as modular components, they may be readily transportable, relatively easy to install, and substantially self-contained.

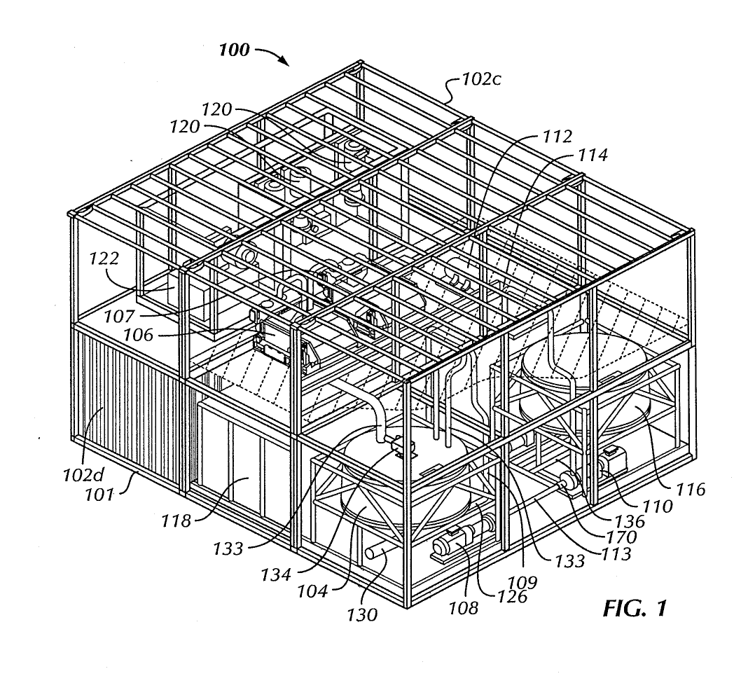

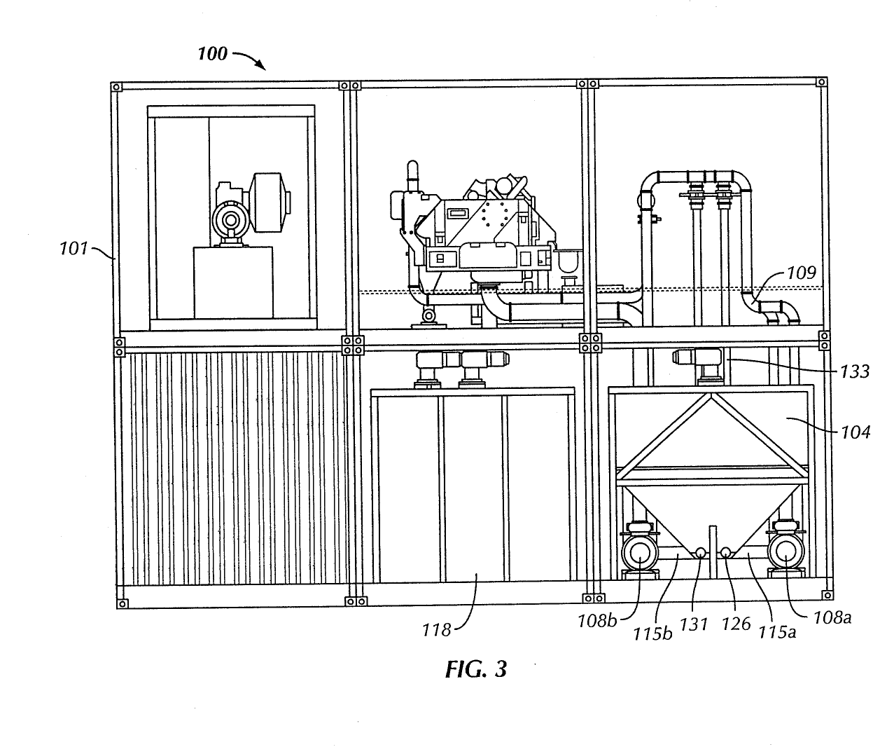

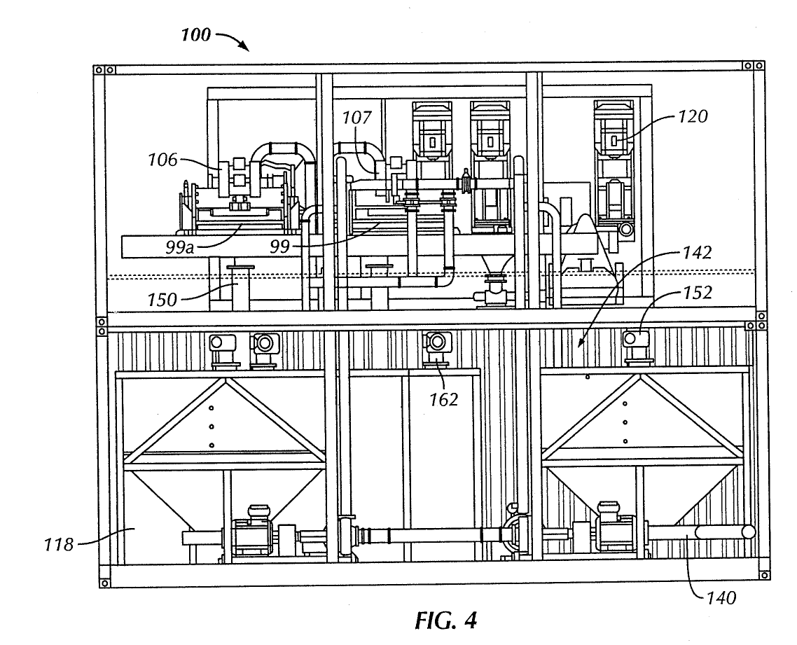

Referring to FIGS. 1-4 together, various views of a waste processing system according to embodiments of the present disclosure are shown. In this embodiment, system 100 is a module system constructed and housed within a support structure 101. Support structure 101 may provide for the modularity of the system, such that system 100 may be transported and used in remote locations. System 100 may also include lift points (not shown), so that cranes or other devices may be used to move system 100. In an exemplary embodiment, support structure 101 may be formed from segmented carbon steel support beams that are welded or bolted together.

FIGS. 1-4 further show system 100 having a first container 104. The first container 104 may have an inlet 130 and an outlet 126 disposed thereon. In certain embodiments, the first container 104 may have additional inlets and outlets, such as inlets 133. The additional inlets and outlets may be used for transferring drilling waste between various components of the system 100. In one embodiment, the first container 104 may be a coarse cuttings tank or a cuttings receiving tank. The first container 104 may also include a mixing device 134 to prevent drilling waste in first container 104 from compacting/cementing.

To control the flow of drilling waste through the container, a valve (not shown) may be added to one or more of the inlets of the first container 104. Those of ordinary skill in the art will appreciate the valve may include airtight rotational valves, three-way valves, or other valves capable of controlling a flow of drilling waste. In some embodiments, a valve may also be added to one or more of the outlets of the first container 104.

Additionally, first container 104 may have a circular external geometry, with a plurality of inlets and outlets for receiving and discharging drilling waste therethrough. The first container 104 may be any size or shape that is needed to meet operational needs. Though first container 104 is depicted with a circular shape, it may include various external or internal geometries. For example, in certain aspects, the first container 104 could be a rectangular horizontal drum. The first container may also have other configurations, such as floating roof tanks. Internally, first container 104 may have an internal weir or baffle arrangement (not shown). In other embodiments, the first container may be ventilated and configured with a pressure relief system (not shown).

FIGS. 1-4 also illustrate system 100 having pump 108a in fluid communication with an outlet 126 of the first container 104. In one embodiment, the pump 108a may be located within support structure 101 proximate the first container 104. In other aspects, the pump 108a may be in fluid communication with the first container 104 and configured to circulate or transfer drilling waste. In still other aspects, a suction side 115a of pump 108a may be in fluid communication with other outlets on the first container 104.

Pump 108a may be a centrifugal pump disposed horizontally or vertically, the choice of which may depend upon spatial or process requirements. However, pump 108a may also include non-centrifugal pumps. For example, pump 108a may be multi-stage, positive displacement, or single-impellar pumps. Additionally, system 100 may include a plurality of pumps 108a and 108b. As illustrated, pumps 108a and 108b may be in fluid communication with the first container, whereby pump 108b is operatively configured akin to pump 108a.

Pumps 108a and 108b may have internal components such as shafts, bearings, impellers and/or diffusers (not shown) that may be formed from materials known in the art to reduce the wear and increase the life of pump components. For example, shafts, bearings, impellers and/or diffusers may be formed from a ferritic steel material, a ceramic material or a composite material including nickel, chrome, and silicone (i.e., NiResist™, 5530 alloy). Additionally, the impellers and/or diffusers may be coated with a wear-resistant material to reduce wear on the pump components. For example, coatings may include polymer-based (e.g., polyurethane), ceramics, metals, or hardfacing. Pumps 108 a,b may also be coupled to a drive device (not shown), such as a direct drive, belt drive, variable speed drive, variable frequency drive, inverter, or gas drive.

Those of ordinary skill in the art will appreciate that the lines (e.g., suction, discharge, transfer, etc.) in system 100 may include piping or other comparable conduit material. The lines may include various cross-sectional geometries and dimensions. For example, discharge line 109 may include square, circular, rectangular, or elliptical cross-sections. These lines may also contain additional components, such as flow control devices, valves, restricting orifices, etc.

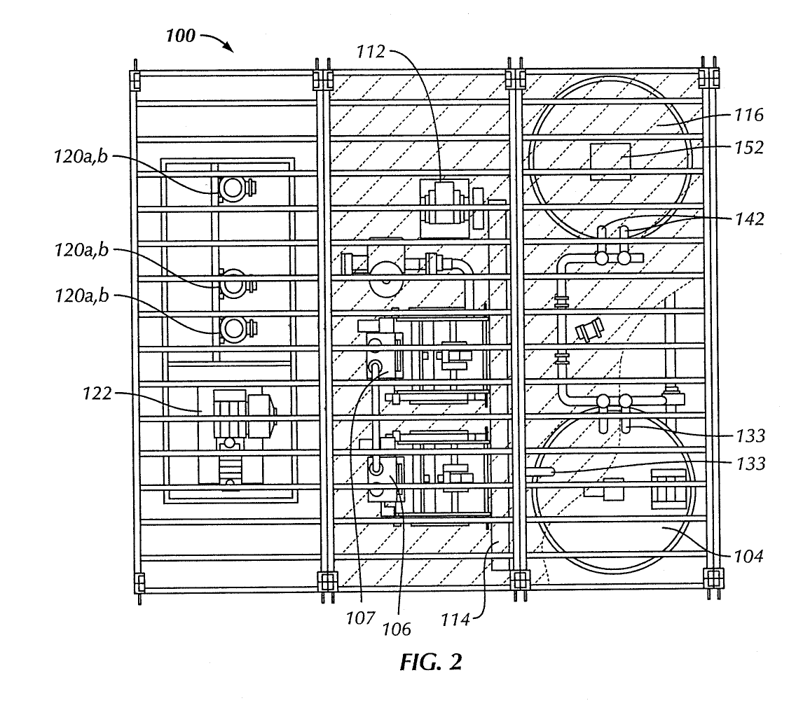

As shown, system 100 may also include a second container 116, similar in nature to the first container 104. However, it is not necessary that the first container 104 and second container 116 be identical. The second container 116 may include an inlet 140 and an outlet 136. In one embodiment, the second container 116 may have additional inlets and outlets, including inlet 142. The additional inlets and outlets may be used for transferring drilling waste between various components of the system 100. In one embodiment, the second container 116 may be a fines cuttings tank or a secondary cuttings receiving tank. The second container 116 may be any size or shape that is needed to meet operational needs. In certain aspects, the second container 116 may also include a mixing device 152 (FIG. 2).

To control the flow of drilling waste through the second container 116, a valve (not shown) may be added to one or more of the inlets. Those of ordinary skill in the art will appreciate the valve may include airtight rotational valves, three-way valves, or other valves capable of controlling a flow of drilling waste and/or cuttings. In some embodiments, a valve (not shown) may be added to any of the outlets of the second container 116. Thus, the flow of drilling waste through the second container 116 may be controlled by adjusting one or more valves.

Second container 116 may also have a circular external geometry, with a plurality of inlets and outlets for receiving and discharging drilling waste therethrough. The second container 116 may be any size or shape that is needed to meet operational needs. Though second container 116 is depicted with a circular shape, it may include various external or internal geometries. For example, in certain aspects, the second container 116 could be a rectangular horizontal drum. The second container may also have other configurations, such as floating roof tanks. Internally, second container 116 may have an internal weir or baffle arrangement (not shown). In other embodiments, the first container may be ventilated and configured with a pressure relief system (not shown).

System 100 may also have a second pump 110a in fluid communication with an outlet of the second container 116. In one embodiment, the pump 110a may be located within structure 101 proximate the second container 116. In another embodiment, the pump 110a may be in fluid communication with the second container 116 to circulate or transfer drilling waste. As shown, a suction side 170 of the pump 110a may be connected to the outlet 136. However, the suction side 170 may be connected to additional outlets on the second container.

Pump 110a may be a centrifugal pump disposed horizontally or vertically, the choice of which may depend upon spatial or process requirements. However, pump 110a may also include non-centrifugal pumps. For example, pump 110a may be multi-stage, positive displacement, or single-impellar pump. Additionally, system 100 may include a plurality of pumps 110a and 110b. As illustrated, pumps 110a and 110b may be in fluid communication with the second container, whereby pump 110b is operatively configured like pump 110a.

Pump 110 may have internal components such as shafts, bearings, impellers and/or diffusers (not shown) that may be formed from materials known in the art to reduce the wear and increase the life of pump components. For example, shafts, bearings, impellers and/or diffusers may be formed from a ferritic steel material, a ceramic material or a composite material including nickel, chrome, and silicone (i.e., NiResist™, 5530 alloy). Additionally, the impellers and/or diffusers may be coated with a wear-resistant material to reduce wear on the pump components. For example, coatings may include polymer-based (e.g., polyurethane), ceramics, metals, or hardfacing. Pump 108a may be coupled to a drive device (not shown), such as a direct drive, belt drive, variable speed drive, variable frequency drive, inverter, or gas drive.

System 100 may also include a plurality of separators 106, 107. Separators 106, 107 may be used to separate drilling waste into a fluids phase (i.e., “underflow”), which may pass through screens (not shown) of the separators 106, 107 and be directed towards other areas of the system 100. Separators 106, 107 may also separate drilling waste into a separated solids phase (i.e., “overflow”) that may be retained on the screens and may exit the separators 106, 107 at a discharge end 99a, 99, respectively. Those of ordinary skill in the art will appreciate that in certain embodiments, system 100 may include less than two separators, or more than two separators.

In one embodiment, separators 106, 107 may include a vibratory shale shaker. While a number of different vibratory separators are known in the art, an example of a vibratory separator that may be used according to embodiments of the present disclosure is the MONGOOSE PT™, commercially available from M-I LLC, Houston, Tex. Separator 107 may be fitted with any size screen (not shown) as required by operational constraints. In some aspects, the separators 106, 107 may be fitted with a 300 micron screen, such that an overflow composition that may have retained particles greater than about 300 microns. In other aspects, the separators 106, 107 may be fitted with a 100 micron screen, such that the overflow composition may include particles greater than about 100 microns. The separators may also include a control system (not shown), such that variables effecting the separatory operation may be controlled. Examples of variables that a drilling operator may need to adjust during the separatory operation include a type of motion used and a deck angle.

FIGS. 1-4 show conveyor 114 disposed adjacent separators 106, 107. The conveyor may be used to capture overflow leaving the separator so the overflow may be transferred to other components of system 100. In one embodiment, the transferring occurs via a screw conveyor 114; however, any conveyance system known in the art may be used. Examples of conveyance systems may include gravity feed, pneumatic transfer, vacuum transfer, fluid connections, and other mechanical conveyers.

FIGS. 1-4 together show conveyor 114 extending toward a mechanical degrading device 112. The mechanical degrading device 112 may be a grinder that produces a ground waste product. Grinder 112 may include a rollermill, ball mill, or hammermill, and may further include multiple grinders in series or parallel configuration (not shown). In one embodiment, the grinder may be a single-motor driven grinder operated by a 75 horse power motor. In another embodiment, the grinder may be driven by a single motor operating in the range of 50 to 80 horsepower. In one embodiment, the grinder 112 may produce ground waste in the range of 5 to 30 tons per hour. In another embodiment, the amount of ground waste produced by the grinder may be less than 25 tons per hour.

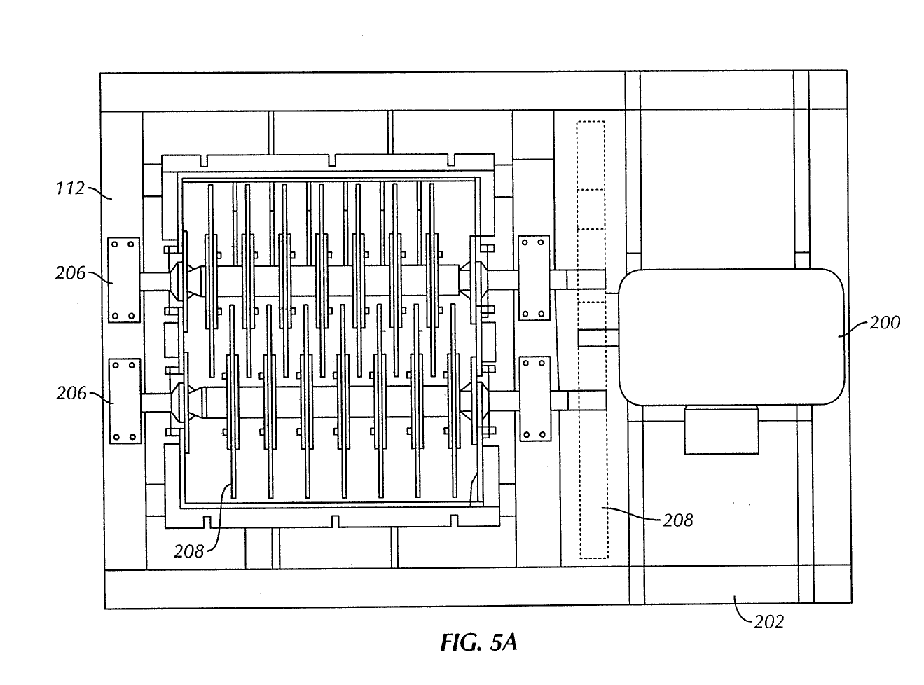

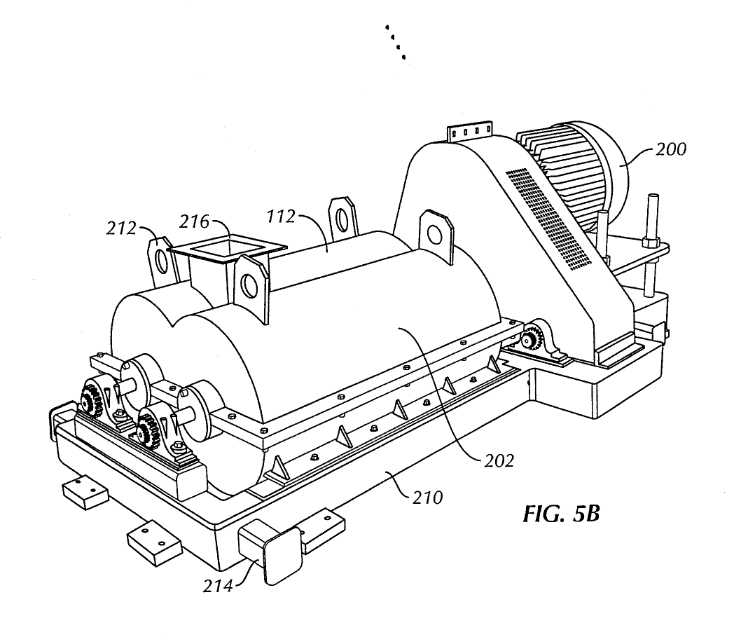

Referring to FIG. 5a, an overhead sectional view of the grinder 112 according to embodiments of the present disclosure is shown. In this embodiment, grinder 112 has a single motor 200. The grinder may also have casing 202 that houses an interconnecting shaft 204 and a pair of axially aligned rotating assemblies 206. The assemblies may each have a plurality of disc-shaped members 208 disposed along each of the rotating assemblies 206. In one embodiment, the rotating assemblies 206 are operatively connected to the single motor 200 by the interconnecting shaft 204.

Referring to FIG. 5b, an external view of the grinder 112 according to embodiments of the present disclosure is shown. In this embodiment, grinder 112 is enclosed by the casing 202, whereby the casing may be attached to a frame 210. Either the frame 210 or the casing 202 may have lifting lugs 212 and/or lifting bars 214. The frame 210 and the casing 202 may be connected to one another by any means known in the art, such as bolting. The grinder 112 may also include an inlet 216 disposed on the grinder 112, as well as an outlet (not shown). Inlet 216 may be used for receiving drilling waste, while the outlet may be used for discharging ground waste.

Referring back to FIGS. 1-4, system 100 may further include a third container 118. Similar to the first and second containers 104 and 116, third container 118 may be of the same material of construction, and the third container 118 may be located within structure 101. The third container 118 may be a holding tank or storage reservoir located adjacent either the first and/or second containers 104, 116. However, the location of the third container 118, in certain aspects, may be disposed proximate system 100, but not located within structure 101.

Those of ordinary skill in the art will appreciate that third container 118 may include any type of storage vessel known in the art, such as a pressurized vessel. One type of pressure vessel that may be used in embodiments disclosed herein includes an ISO-PUMP™, commercially available from M-I LLC, Houston, Tex.

Additionally, third container 118 includes an inlet 150. In one embodiment, the inlet 150 may be located below separators 106, 107. In another embodiment, third container 118 may have multiple inlets, where any of the inlets may be in fluid communication with a discharge side of a third pump 120. There may also be additional outlets (not shown) disposed on the third container 118. Additional inlets and outlets may be used for receiving and discharging drilling waste to other components of system 100.

System 100 may further include multiple pumps 120a and 120b in fluid communication with an outlet (not shown) of the third container 118. In this embodiment, the pumps 120a and 120b may be located within structure 101 proximate to the third container 118. A suction side of either of the pumps 120a or 120b may be connected to an outlet of the third container 118. In some aspects, the pumps 120 a,b may also be in fluid communication with container 118 via additional outlets on the third container. In further aspects, pumps 120a and 120b may include a suction side connected to a bypass line (not shown) that bypasses flow around the third container 118. Pumps 120 a,b may include a centrifugal pump; however, the type of pump 120 used in system 100 is not limited. For example, pump 120 could be a positive displacement pump, or a booster pump.

System 100 may have a high pressure (“HP”) pump 122 within the structure 101. In one embodiment, HP pump 122 may be located proximate, and in fluid communication with pump 120. Alternatively, HP pump 122 may be in fluid communication with the third container 118. HP pump 122 may also have a discharge side in fluid communication with a downhole formation (not shown). For example, HP pump 122 may be in fluid communication with third container 118, such that pump 122 may pressurize drilling waste for injection into a downhole formation.

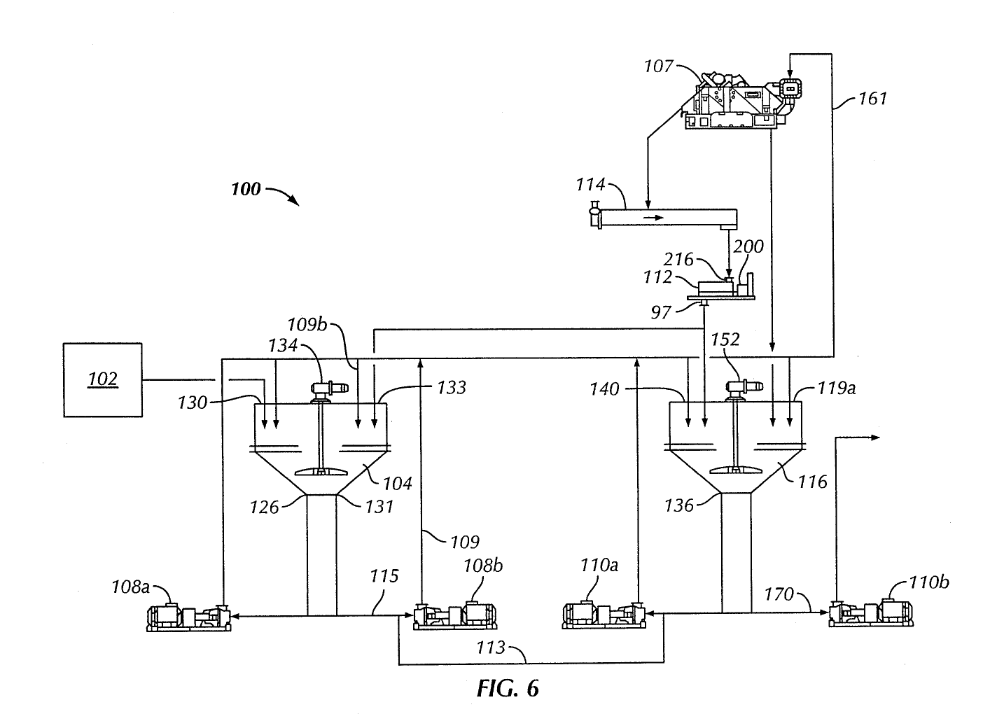

Referring to FIG. 6, a schematic operating flow diagram of waste processing system 100 according to embodiments of the present disclosure is shown. In this embodiment, the operation of system 100 may include drilling waste provided from a source 102. The source 102 may be more than one individual source, and may contain, for example, a return drilling fluid from a wellbore (not shown) having solid particulate matter entrained therein. In certain situations, it may be advantageous for the returned drilling fluid to be conditioned prior to being transmitted to system 100. Examples of conditioning may include chemical and/or physical treatment, which may allow downstream separatory operations to be more effective and/or more efficient.

In one embodiment, source 102 may be a reservoir. Examples of reservoirs may include storage tanks, pits, collection vats, and waste vessels, which those of ordinary skill in the art will appreciate may already exist as part of the rig infrastructure. In other embodiments, source 102 may be cuttings boxes, sumps, pits, or a pressure or atmospheric vessel configured for transferring drilling waste to the system 100. Those of ordinary skill in the art will appreciate that in certain embodiments, source 102 may include a flow line. The flow line may include piping or other conduits to provide drilling waste from source 102 to system 100. In some embodiments, the drilling waste may be provided from source 102 to first container 104.

FIG. 6 illustrates that first container 104 may be configured to receive a feed of drilling waste from feed source 102. Inlet 130 may be in fluid communication with the feed source 102, and the outlet 126 may be in fluid communication with a pump 108 that may be located proximate the outlet 126. In certain aspects, the first container may also receive drilling waste from a circulated flow provided by pumps 108a or 108b, where the pumps are in fluid communication with outlets 126 and 131, respectively. In addition to circulating flow to the first container 104, pumps 108a or 108b may be configured to transfer drilling waste to a second container 116. The first container 104 may also receive ground waste from a mechanical degrading device 112.

System 100 may have multiple pumps in fluid communication with the first container 104. For example, as represented in FIG. 6, system 100 may include multiple pumps 108a and 108b in a parallel configuration, such that the pumps 108a and 108b may be used to circulate a flow of drilling waste within first container 104 for further processing, as well as transfer drilling waste via a transfer line 111 to a second container 116. As shown, the pumps 108a and 108b may have a suction side connected to a bypass line 113, such that drilling waste may flow from the second container 116 to the pumps.

In operation, drilling waste enters pump 108a from a suction line 115a, wherein the pump 108a pressurizes the flow and circulates the waste via a discharge line 109 that branches to a return line 109b or to other equipment in system 100, depending on operating conditions. In one aspect, pump 108a may discharge drill waste to separator 107 thru transfer line 161.

System 100 may also include a second container 116 having various inlets and outlets. As shown by FIG. 6, the container may have multiple inlets in fluid communication with pumps 108a and 108b and there may be multiple pumps 110a and 110b in fluid communication with multiple outlets of the container 116. In addition to receiving flow from pumps 108a and 108b, the second container 116 may also receive ground waste from the mechanical degrading device 112. When desired, the second container may also have drilling waste fed to it through a circulating flow from pumps 110a and 110b. In addition to circulating flow to the second container, pumps 110a and 110b may discharge flow to the separator 107. In some embodiments, pumps 110a and 110b may be bypassed, and flow from the second container 116 may alternatively be discharged from pumps 108a and 108b.

As depicted, second pumps 110a and 110b may be used to circulate the flow to the second container for further processing via discharge line 119, or forward the flow via transfer line to other downstream operations. Though shown as multiple pumps 110a and 110b, the pumps do not have to operate together, nor do they have to be in a parallel configuration. Further, in certain aspects, system 100 may only include one pump 110. In operation, flow from the second container 116 may enter the second pump 110a from a suction line 170, wherein the pump 110a pressurizes the flow and circulates the waste via a discharge line 119 that branches to a return line 119a or to other equipment in system 100, depending on operating conditions. As shown, the pumps 110a and 110b may have the suction side connected to a two-way flow bypass line 113 that may be used for bypassing flow from the first container 104 to the pumps 110a and 110b. In one embodiment, the flow from pumps 110a and 110b may be forwarded through transfer line 161 to separator 107.

Still referring to FIG. 6, system 100 may include the use of separator 107, which may be used to process the drilling waste into an underflow and an overflow. As depicted, and overflow from the separator may be fed to a conveyor 114. In some aspects, the overflow may be gravity fed to the conveyor 114. As overflow is produced from the separator 107 and fed to the conveyor 114, the conveyor 114 may transfer the overflow to the mechanical degrading device 112. The underflow may be transferred from separator 107 back to the second container 116, where the underflow produced from the separator may have particles less than 300 micron.

The overflow received by the mechanical degrading device 112 may be processed into a ground waste. In operation, the conveyor 114 conveys the drilling waste to the inlet 216 of the mechanical degrading device 112. The motor 200 operates to drive the assemblies 206 used for macerating the drilling waste into a ground waste. Typically, the ground waste produced by the mechanical degrading device 112 exits the outlet 97 and may be fed back to the first or second containers 104, 116 for further processing. The overflow produced from the separator may have particles greater than 300 micron. Thus, the ground waste produced from the mechanical degrading device 112 may reduce the particles to less than 300 micron.

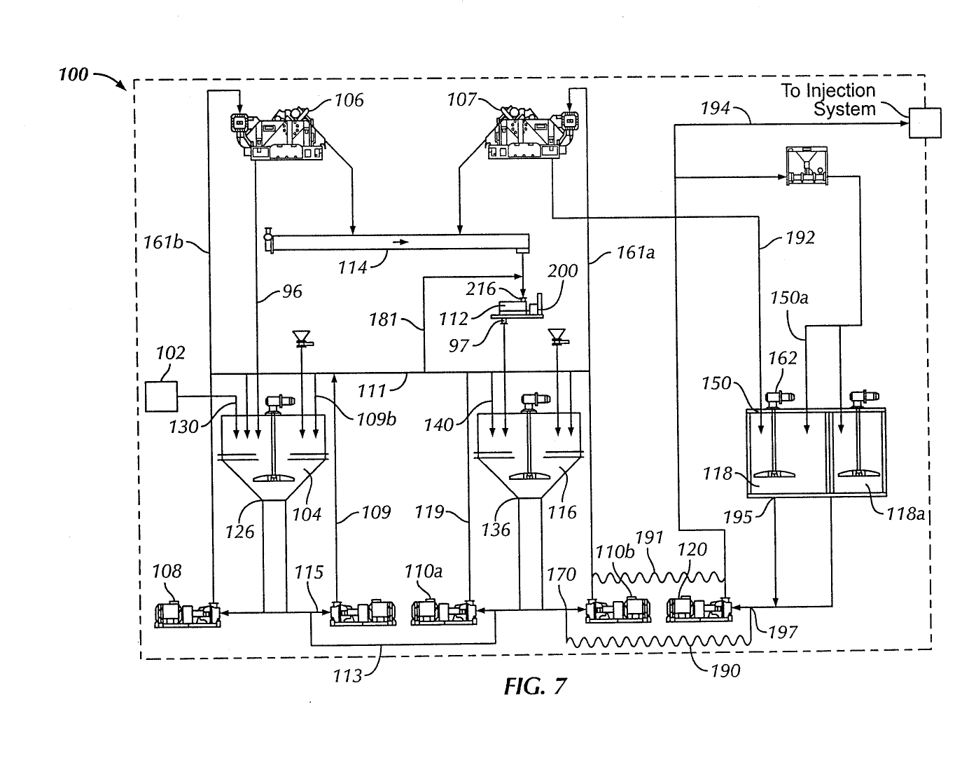

Referring to FIG. 7, a schematic operating flow diagram of an alternate configuration of a waste processing system 100 according to embodiments of the present disclosure is shown. As depicted in this embodiment, system 100 may include a first container 104 that may receive a flow of drilling waste from a feed source 102. The inlet 130 may be in fluid communication with the feed source 102, and the outlet 126 may be in fluid communication with a pump 108a; however, as illustrated, there may be multiple pumps 108a and 108b connected to multiple outlets 126 and 131. In operation, the first container 104 may have drilling waste fed to it by circulated flow from pumps 108a and 108b. In addition to circulating flow to the first container, pumps 108a and 108b may transfer flow to the second container 116. In still other aspects, the first container may be fed ground waste from the mechanical degrading device 112. In other aspects, the first container may receive flow from other components of system 100. For example, separator 106 may provide an underflow to first container 104.

As illustrated, system 100 may have multiple pumps 108a and 108b in a parallel configuration that may be used to circulate the flow back to first container 104 for further processing, as well as forward flow via a transfer line 111 to other downstream operations. The pumps 108a and 108b may have their suction side connected to a bypass line 113 that transfers flow from the second container 116 to the pumps. Though shown as multiple pumps 108a and 108b, the pumps do not have to operate together, and in certain aspects, there may only be one pump 108 if desired.

In operation, drilling waste may enter pump 108a from a suction line 115a, wherein the pump 108a pressurizes the flow and circulates the waste via a discharge line 109 that branches to a return line 109b or to other equipment in system 100, depending on operating conditions. In one aspect, the pumps 108a and 108b may discharge drill waste to separators 106, 107 thru transfer lines 161, 161a. In other aspects, the pumps may discharge drilling waste to the grinding device 112 via transfer line 181.

System 100 may also include a second container 116 having various inlets and outlets. As shown in FIG. 7, the container may have multiple inlets in fluid communication with pumps 108a and 108b, and there may be multiple pumps 110a and 110b in fluid communication with multiple outlets. In addition to receiving flow from pumps 108a and 108b, the second container 116 may receive ground waste from the mechanical degrading device 112. When required, the second container may also receive drilling waste from a circulating flow from pumps 110a and 110b. In addition to circulating flow to the second container 116, pumps 110a and 110b may discharge flow to the separators 106, 107, or the pumps may discharge flow directly to the mechanical degrading device 112. In some embodiments, pumps 110a and 110b may be bypassed via two-way flow bypass line 113, such that flow from the second container 116 may alternatively be discharged from pumps 108a and 108b.

As depicted in FIG. 7, second pumps 110a and 110b may be used to circulate the flow to the second container for further processing via discharge line 119, or forward the flow to other components of system 100. Though shown as multiple pumps configured in parallel operation, the pumps do not have to operate together, nor do they have to be in a parallel configuration. Further, there may only be one pump 110 if desired. In operation, flow from the second container 116 may enter the second pumps 110a and 110b from a suction line 170, wherein the pumps pressurize the flow and circulate the waste via a discharge line 119 that branches to a return line 119a or to other components in system 100, depending on operating conditions. In one embodiment, the flow from pumps 110a and 110b may be forwarded through transfer lines 161a and 161b to separators 106, 107. As shown, the pumps 110a and 110b may have their suction side connected to a two-way flow bypass line 113, such that flow may be bypassed from the first container 104 to pumps 110a and 110b. Additionally, pumps 110a and 110b may be in fluid communication with a third container 118.

System 100 may include multiple separators 106, 107, which may be used to process the drilling waste into an underflow and an overflow. In operation, an overflow from the separators 106, 107 may be fed to a conveyor 114. In some aspects, the overflow may be gravity fed to the conveyor 114. As overflow is produced from the separators 106, 107 and fed to the conveyor 114, the conveyor 114 may transfer the overflow to the mechanical degrading device 112. As shown, underflow produced from the separator 107 may be fed to a third container 118. In one aspect, the underflow may be gravity fed to the third container 118. Alternatively, the separator 106 may provide underflow to the first container 104 via transfer line 96. This may provide an operator greater flexibility to further process underflow within system 100.

The overflow received by the mechanical degrading device 112 may be processed into a ground waste. In operation, the conveyor 114 conveys the drilling waste to the inlet 216 of the mechanical degrading device 112. The motor 200 operates to drive the assemblies 206 used for macerating the drilling waste into a ground waste. Typically, the ground waste produced by the mechanical degrading device 112 exits the outlet 97 and may be fed back to the first or second containers 104, 116 for further processing. In one embodiment, the ground waste is gravity fed to the containers.

FIG. 7 also illustrates system 100 including use of third container 118, which may be multiple containers 118, 118a. As underflow is produced by the separator 107, it may gravity drain to the third container via transfer line 192. For example, inlet 150 may be in fluid communication with the separator 107 via the transfer line 192. In another embodiment, the inlet 150a may receive a circulation flow from pump 120. The third container, which may be storage vessel, may be used for holding the underflow for a period of time. Depending on operational considerations, pump 120 may be used to transfer flow from the third container to an injection system via transfer line 194.

Third container 118 may be a raw material storage tank, waste storage tank, or any other vessel commonly used in association with processing, handling, or storing drilling waste. Specifically, third container 118 may include cuttings boxes, ISO-tanks, and pneumatic transfer vessels. In some embodiments, third container 118 may include several individual vessels connected to allow the transference of underflow therebetween. The third container 118 may be portable, as such, that those of ordinary skill in the art will appreciate that container 118 may be used for both storage and transport of drilling waste.

Additionally, storing or handling of the underflow may be to facilitate the transfer of the underflow to a waste injection system through a transfer line 194. The outlet 195 of the third container 118 may be in fluid communication with third pump 120. Alternatively, the third container 118 may be in fluid communication with second pumps 110a and 110b via a two-way flow bypass line 190.

In accordance with embodiments disclosed herein, system 100 may include the use of high-pressure pumps 122 (FIG. 1), low-pressure pumps 120, or both types of pumps, to facilitate the transfer of the processed waste into a wellbore. In one embodiment, the pumps may be in fluid communication with each other, so as to control the pressure at which the waste is injected downhole. However, to further control the injection of the slurry, additional components, such as pressure relief valves (not independently shown) may be added in-line prior to the dispersal of the waste into the wellbore. Pressure relief valves may help control the pressure of the injection system to increase the safety of the operation and/or to control the speed of the injection to further increase the efficiency of the waste injection. From the pump 122, the drilling waste may then be transferred to downhole tubing for injection into the wellbore (not shown). Downhole tubing may include flexible lines, existing piping, or other tubing know in the art for the re-injection of cuttings into a wellbore.

Embodiments disclosed herein also pertain to a method of processing drilling waste. The method may include providing drilling waste from a wellbore to a source, which may be a reservoir. The method may include transferring drilling waste from the source to a first container, which may be located in a structure containing other equipment used in the method for processing waste. The method may further include a set of pumps for circulating flow within the first container, and for pumping drilling waste from the first container to a separator, which may be a vibratory shale shaker that produces an overflow and underflow.

The method may also include receiving the overflow from the separator in a grinder. In an embodiment, the overflow may be conveyed from the separator to the grinder by an intermittent conveying step. Once the grinder receives the overflow, the overflow is processed in the grinder to produce a ground waste. After grinding, the ground waste is discharged from the grinder to a second container.

The method may further include operating conditions yielding an amount of overflow received by the grinder in the range of 5 to 30 tons per hour. In one embodiment, the amount of overflow received by the grinder may be less than 25 tons per hour. In certain embodiments, the overflow composition may contain particles greater than 300 microns.

In addition to producing an overflow, the separator may also produce an underflow, such that the method of processing drilling waste may further include the steps of receiving the underflow from the separator into a second container. The second container may also be located in the structure, and may be used for holding processed drilling waste. The method may include another set of pumps for circulating flow within the second container, as well as using the pumps to convey processed drilling waste through an outlet of the second container, and injecting the drilling waste into a downhole formation.

The method of injecting a slurry into a formation in accordance with embodiments disclosed herein may include providing a flow of processed waste to a high pressure injection pump, increasing the pressure of the flow, and delivering or pumping the waste downhole into the formation.

Advantageously, embodiments disclosed herein may provide systems and methods for processing a drilling waste that provides reinjection slurries in compliance with environmental regulations. Additionally, the systems and methods disclosed herein may allow a drilling operator to more efficiently process drilling waste. The process may further increase the efficiency of the system, while producing cleaner reinjection slurries for recycling into the well bore. Embodiments disclosed herein may also reduce or eliminate shut down time as a result of particulate accumulation. Reduced particle size also means lower pressure drops that may result decreased energy consumption. The device may provide the ability of operations to efficiently and profitably produce hydrocarbonaceous fluids from offshore and onshore environments, as well as locations that require very low or zero emissions from disposed waste.

Advantageously, embodiments disclosed herein may also allow for a modularized drilling waste system that may be transported and installed on drilling rigs with relative ease. Because of the system's modularity, the entire separatory operation may be maintained within a support structure, installed and uninstalled on a rig as may be necessary. As such, the modularity of the system may provide a solution to bulky systems of existing rigs, especially tender-assist and other mobile drill rigs. Furthermore, because the system may be modular and substantially self-contained, systems in accordance with the present disclosure may be retrofitted onto existing rigs. Such retrofitting operations may further increase the cuttings processing and drilling efficiency of offshore rigs. The modularity and retrofitting aspects of the present disclosure may further provide the advantage of faster methods for rigging up and manipulating aspects of drilling waste management.

Advantageously, embodiments disclosed herein may further provide for systems and methods that allow for the processing and injecting of reduced particle size solids content of a slurry at a work site.

While the present disclosure has been described with respect to a limited number of embodiments, those skilled in the art, having benefit of this disclosure, will appreciate that other embodiments can be devised which do not depart from the scope of the disclosure as described herein. Accordingly, the scope of the invention should be limited only by the attached claims.

What is claimed is:

1. A waste processing system comprising:
a first container having an inlet and an outlet;
a separator in fluid communication with the first container; and
a mechanical degrading device configured to receive an overflow from the separator.

2. The waste processing system of claim 1, further comprising:
a second container having an inlet and an outlet, wherein the inlet is in fluid communication with the separator.

3. The waste processing system of claim 1, further comprising a first pump configured to circulate flow within the first container.

4. The waste processing system of claim 1, wherein the mechanical degrading device is a hammermill grinder.

5. The waste processing system of claim 1, wherein the mechanical degrading device is driven by a single motor.

6. The waste processing system of claim 5, wherein the single motor has a horsepower value in the range of 50 to 80.

7. The waste processing system of claim 1, wherein the mechanical degrading device is a grinder further comprising
a single motor;
an interconnecting shaft;
a pair of axially aligned rotating assemblies, wherein each of the assemblies has a plurality of disc-shaped members disposed along each of the rotating assemblies, wherein the rotating assemblies are operatively connected to the single motor by the interconnecting shaft.

8. A system for processing a waste stream for downhole injection, the system comprising:
a first container having an inlet and an outlet;
a separator in fluid communication with the first container;
a mechanical degrading device configured to receive an overflow from the separator; and
a second container in fluid communication with the first container and the mechanical degrading device, wherein the second container is configured to receive a ground waste from the mechanical degrading device.

9. The system of claim 8, further comprising a pressure vessel configured for transferring waste from a waste source to the first container.

10. The system of claim 8, wherein the second container receives an underflow from the separator.

11. The system of claim 8, wherein the separator is a vibratory shaker.

12. The system of claim 11, wherein the vibratory shaker comprises a 300 micron screen.

13. The system of claim 8, further comprising:
a third container having an inlet and an outlet, wherein the inlet of the third container is in fluid communication with the second container;
at least one high pressure pump, wherein the at least one high pressure pump has a suction side in fluid communication with the outlet of the third container, and a discharge side in fluid communication with a downhole formation.

14. The system of claim 8, wherein the mechanical degrading device is driven by a single motor.

15. A method of processing drilling waste comprising:
providing drilling waste to a source;
transferring drilling waste from the source to a first container;
pumping drilling waste from the first container to a separator;
receiving an overflow from the separator in a mechanical degrading device;
processing the overflow in the mechanical degrading device; and
discharging the processed overflow from the mechanical degrading device to a second container.

16. The method of claim 15, wherein the amount of overflow received by the mechanical degrading device is in the range of 5 to 30 tons per hour.

17. The method of claim 15, wherein the overflow comprises particles greater than about 300 microns.

18. The method of claim 15 further comprising:
storing processed drilling waste in the second container;
using a pump to convey processed drilling waste through an outlet of the second container; and
injecting the drilling waste into a downhole formation.

19. The method of claim 18, wherein the mechanical degrading device is driven by a single motor.

20. The method of claim 18, wherein the single motor has a horsepower value in the range of 50 to 80.
